(19) United States
(12) Patent Application Publication
(10) Pub. No.: US 2011/0184898 A1
(43) Pub. Date: Jul. 28, 2011

(54) Weight-Prediction System and Method Thereof

(75) Inventors: Tsuo-Hung Lan, Taipei (TW); Hesien-Jane Chiu, Taipei (TW); Meng-Shien Wu, Taipei (TW)

(73) Assignee: NATIONAL YANG MING UNIVERSITY, Taipei (TW)

(21) Appl. No.: 12/751,851

(22) Filed: Mar. 31, 2010

(30) Foreign Application Priority Data
Jan. 22, 2010 (TW) 099101731

(51) Int. Cl. G06N 3/08; G06N 7/02; G06N 5/04

(52) U.S. Cl. 706/21; 706/52; 706/25

(57) ABSTRACT

The present invention provides a weight-prediction method comprising the following steps: providing the first-period data and the second-period data of basic users and proving users, respectively; using an Artificial Neural Network method to analyze the first-period data and second-period data of basic users to calculate a basic parameter; analyzing the first period data of proving users by using a Fuzzy Inference system based on the basic parameter and then calculate a predictive data; comparing the predictive data with the second-period data of proving users and determining if the predictive data is in an acceptable range. If the predictive data is certainty in the acceptable range, the basic parameter is defined as a predictive parameter.

This application claims the benefit of priority under 35 U.S.C. § 119 from the prior Taiwan patent application 099101731, filed Jan. 22, 2010, the entire content of which is hereby incorporated by reference in its entireties.

### BACKGROUND OF THE INVENTION

1. Field of the Invention

This invention relates to a weight-prediction method; particularly, a weight prediction method for different regions or different races.

2. Description of the Prior Art

Weight control has been an important health indication and evaluation particularly emphasized nowadays. In medication, many diseases have been found to be relevant to obesity or being skinny, such as cancer, diabetes, and cardiovascular disease, which takes a large part of medication expenses. (American Journal of Public Health 1999;89:1194-1199) In the new era of cosmetic health management, particularly in the youngster community, people care even more about their thoughts and opinions about their appearance and other subjective value. The so-called body image further affected the level of mental healthiness. In short, the caring and needs of weight control has gotten more and more attention. If there is a method that can easily predict weight changes, important health evaluation information can be provided.

The general weight evaluation method used internationally is calculating BMI (Body Mass Index), the equation is: BMI=weight (kg)/height(m2). One's weight is normal when his/her BMI is in the range of 22±10%. One is Obese, when his/her BMI is over 24. One is too skinny; when his/her BMI is lower than 18. The prediction of weight changes is often implemented using BMR (Basal Metabolic Rate) as the assistant indicator. BMR indicates the minimum calories consumed by a person to maintain his/her vitality when he is laid still, which may vary with age, gender, body composition and hormone status.

If the correct BMR of a person can be gained, the daily consumed calories can be evaluated according to the value and the intense level of daily work, with the incorporation of the intake of food, to calculate the weight changes. Generally, the method of measuring BMR is done by formulation and only a few parameters are taken into consideration. However, the diets and life styles of different regions and even the genes of different races all cause different levels of weight changes. Therefore, this kind of formula is not suitable for the evaluation of the population in different environments or regions.

### SUMMARY OF THE INVENTION

This invention provides a weight measuring method, comprising: providing the first-period data and the second-period data of basic users and proving users, respectively; using an Artificial Neural Network method to analyze the first-period data and second-period data of basic users to gain a basic parameter; analyzing the first period data of proving users using a Fuzzy Inference system according to the basic parameter and gain a predictive data; comparing the predictive data with the second-period data of proving users and determining if the predictive data is in the predicted acceptable range. If the predictive data falls in the acceptable range, the basic parameter is defined as a predictive parameter.

This invention further provides a weight prediction system, including: a first input unit, a first processing unit, a second input unit, a second processing unit, an output unit and a storage unit. The first input unit is used to receive user information from a plurality of regions, wherein the user information of each region is further divided into a group of basic user information and a plurality of groups proving user information. The first processing unit is connected to the first input unit having an Artificial Neural Network (ANN) and a Fuzzy Inference system (FIS). The ANN is used to analyze the basic user information to gain a plurality of basic parameters that corresponds to each region, and the Fuzzy Inference system will further analyze the proving user information of each region to examine and adjust the basic parameter, to further produce a plurality of predictive parameters that corresponds to each region.

The second input unit can utilize a variety of methods to receive user information; the second processing unit is connected to the first processing unit and the second input unit, and the user information of the second input unit is analyzed according to one of the predictive parameters of the first processing unit to gain predictive information. The output unit is connected to the second input unit and the second processing unit, and outputs the predictive information; the storage unit is used to store all user information and predictive information. These records are not only provided for prediction but also the learning of the ANN afterwards.

The predictive parameters having reference value can provide highly reliable predictive information. In the future, users only need to input the user information of the first period, the weight prediction method of this invention can be utilized to gain user information of the second period having reference value.

The method of this invention that predicts weight adopts ANN and FIS technology to develop an efficient mode of weight change prediction. With the learning ability of ANN, the experience of prediction can be accumulated to adjust and improve the accuracy of prediction; The FIS technology can be used to establish prediction principles and integrate the principles and the prediction experience of ANN in the same system to sufficiently improve the processing ability for system unreliability and inaccuracy. Meanwhile, having self-learning and organizing ability, along with the parameters that can adjust modes, this invention can learn from and compute on the data of different regions and different races.

For the advantages and spirit of this invention and more detailed embodiment can be further understood by following embodiments and appended drawings.

### BRIEF DESCRIPTION OF THE DRAWINGS

FIG. 1 is the block diagram of the weight prediction method of this invention;

FIG. 2 schematically illustrates the weight prediction system of this invention;

FIG. 3 is the interface drawing of the weight prediction system of this invention; and

FIG. 4 is the application figure of the weight prediction system of this invention.

### DETAILED DESCRIPTION OF THE PREFERRED EMBODIMENT

No matter from the perspective of health or appearance, weight control has been an indicator and evaluation of health that has been emphasized on. This invention provides a weight prediction method that can predict the amount of weight that may be increased or decreased after a period of time under this condition and further reach the goal of controlling weight.

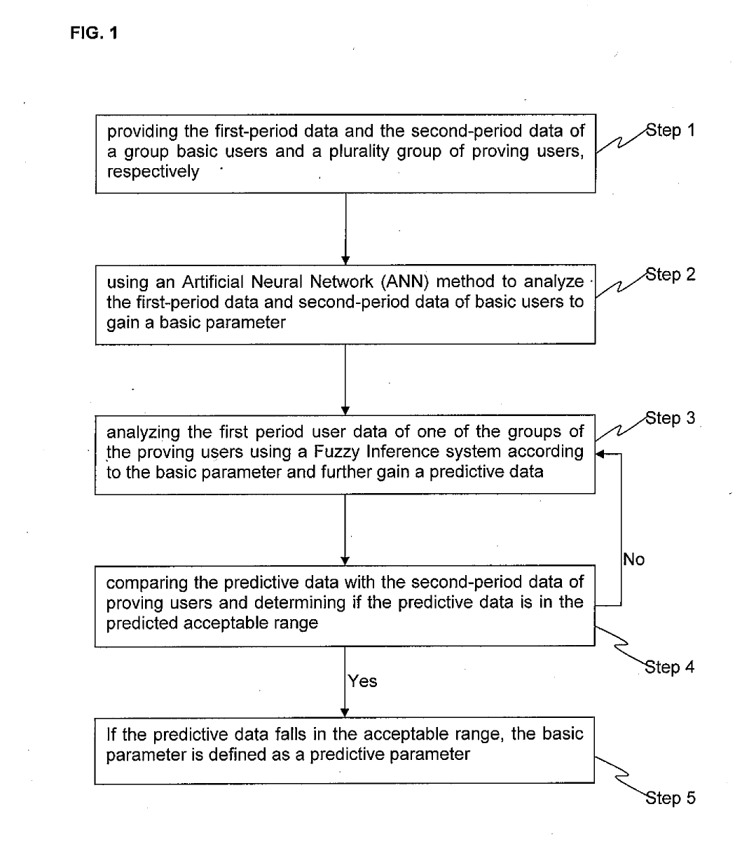

Please refer to FIG. 1, that is the weight prediction block diagram of this invention. The weight prediction method of this invention comprises the following steps:

Step 1: providing the first-period data and the second-period data of basic users and proving users, respectively; this embodiment uses a group of basic user and a group of proving user as an example, the basic user is used for the learning of prediction mode, and the proving user is used for testing the performance of the prediction mode.

In which, the user information needed is the factors that might affect weight change, for example:

(1) Basic information: ID number, name, gender, age

(2) Body size: height, waistline, buttocks

(3) Psychiatric status evaluation: for example stress, emotional status and other clinical reaction to implement psychiatric evaluation table.

(4) Life style: such as diet, exercise, job, smoke, alcohol, sleep quality, and medication.

(5) Genetic factor: for example metabolism, gene or the genetic information about obesity to gain a genetic factor information, such as HTR2A [symbol] HTR2C [symbol] ADRA1A [symbol] ADRA2A [symbol] ADRB3.

(6) Weight data: the weight of the first period and the second period are the beginning weight and the weight after a period of time.

Step 2: using an Artificial Neural Network (ANN) method to analyze the first-period data and second-period data of basic users to gain a basic parameter; this basic parameter indicates the weight change reference values generated by a variety of factors during the period between the first period and the second period.

Step 3: analyzing the first period user data of one of the groups of the proving users using a Fuzzy Inference system according to the basic parameter and further gain a predictive data. This predictive data indicates the predicted weight of the proving user of the second period of being affected by all kinds of factors during the period between the first period and the second period. In which, the predictive data includes:
1. weight prediction: weight prediction value, weight change amount, standard weight.
2. obesity evaluation: the beginning BMI, BMI prediction value and the level of obesity.
3. Waist to hip ratio, WHR

Step 4: the comparison of the predictive data with the second-period data of proving users is mainly used to examine if the weight predicted according to the basic parameter is the same as the weight of the proving users measured during the second period or in the predetermined acceptable range.

Step 5: if the weight predicted according to the basic parameters (predicted data) is the same as the real weight of the proving users, or falls in the predetermined acceptable range, the basic parameters are defined as a predictive parameter, which means the predictive parameter has reference value.

Step 6: if the weight predicted according to the basic parameters (predicted data) is different from the real weight of the proving users, or does not fall in the predetermined acceptable range, the basic parameters will be adjusted and Step 3 will be repeated until the predictive data falls in the predetermined acceptable range.

Therefore, the predictive parameter that has reference value will be able to provide highly reliable predictive data. In the future, if the user information of the first period is input, the weight prediction method of this invention will gain user information of the second period that has reference value. That is to say, the first period is used as the base point and the measured weight after a period of time is predicted according to the weight at that time and the factors that affect the weight.

The weight prediction method of this invention adopts ANN and FIS technology to develop an efficient mode of weight change prediction. With the learning ability of ANN, the experience of prediction can be accumulated to adjust and improve the accuracy of prediction. The FIS technology establish prediction principles using the prediction method that imitate human syntax to make the principal more transparent and easier to be observed and explained.

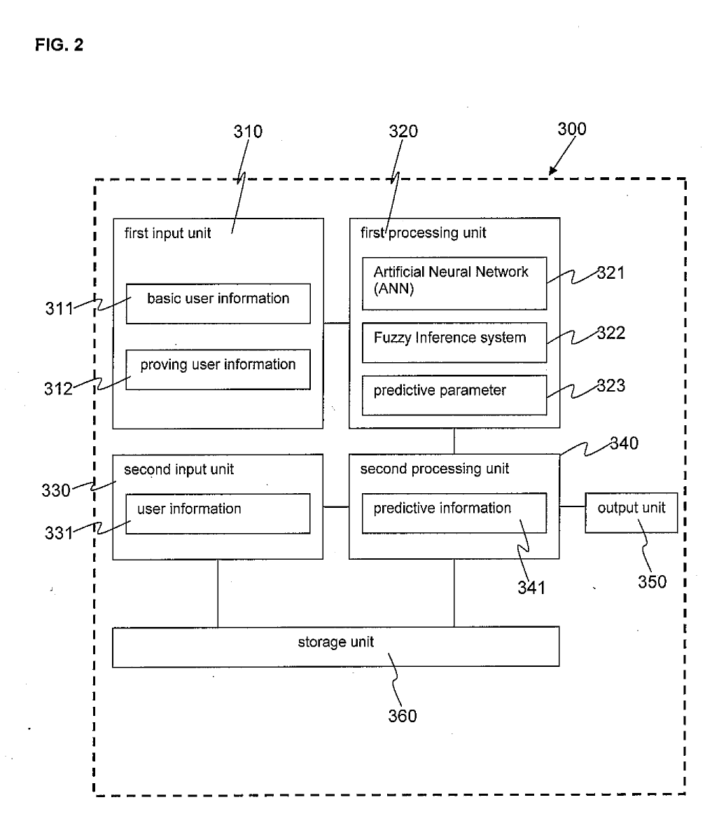

Moreover, this invention also provides a weight prediction system (please refer to FIG. 2; i.e. the schematic view of the weight prediction system of this invention). The weight prediction system 300 of this invention includes a first input unit 310, a first processing unit 320, a second input unit 330, a second processing unit 340, an output unit 350 and a storage unit 360.

The first input unit 310 is used to receive user information from a plurality of regions, in which the user information of each region is further divided into a group of basic user information 311 and a plurality of proving user information 312.

The first processing unit 320 is connected to the first input unit 310 having ANN 321 and FIS 322 technology. Artificial Neural Network (ANN) method is used to analyze the user information to gain a plurality of base parameters corresponding to each region. The Fuzzy Inference system will further analyze the proving user information of each region to examine and adjust the basic parameter to produce a plurality of predictive parameters 323 that correspond to each region.

The second input unit 330 can use a variety of methods to receive a user information 331, such as through network unit; the second processing unit 340 is connected to the first processing unit 320 and the second input unit 330, and analyzes the user information 331 of the second input unit 330 according to one of the predictive parameters 323 of the first processing unit 320 to gain a predictive information 341.

The output unit 350 is connected to the second input unit 330 and the second processing unit 340, and output the predictive information 341; the storage unit 350 is used to store all the user information 331 and predictive information 341. The information is not only used for prediction but also the learning of the ANN afterwards.

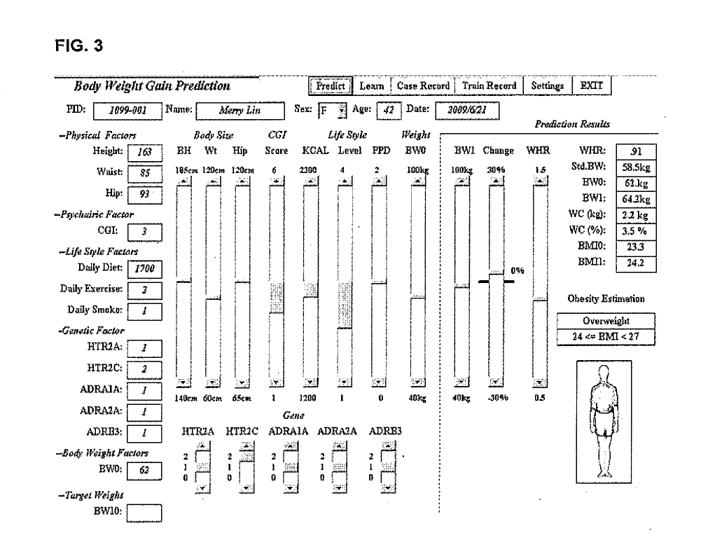

Please refer to FIG. 3, which is the interface of the weight prediction system of this invention. First of all, input user information from the left side of the figure. The user information includes basic data, body shape data, psychiatric status data, life style data, genetic data, weight data and so on; after the second input unit 330 receive the user information 331, the second processing unit 340 analyzes the user information 331 according to the predictive parameters 323 generated by the first processing unit 320 to gain the predictive information 341. The predictive information 341 is displayed on the right side of the figure, which includes weight, weight change, BMI, BMI change, waist to hip ratio information.

Weight prediction system provided by this invention is integrated with the two technologies, ANN 321 and FIS 322 technology. FIS 322 adopts Fuzzy If-Then rules to implement stability description and analysis on human knowledge and prediction process. However, it lacks accurate stability analysis and value adjustment, ANN has great self-learning ability and organizing ability, but the prediction process can not be correctly implemented. Therefore, this invention combines these two methods, which sufficiently improves system processing ability on reliability and accuracy by integrating FIS into ANN; at the same time, this invention has self-learning ability and adjusts mode parameters. In the end, the data of different regions and different races can be learned and computed.

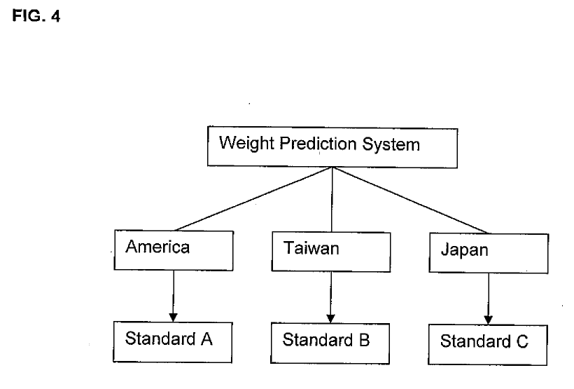

Please refer to FIG. 4, the application figure of the weight prediction system of this invention; for example, the differences in the food culture and lifestyle of Taiwan, Japan and America, the system should be corresponding to different standards. Therefore, after managers input user information of Taiwan, Japan and America, the FIS and ANN of the first processing unit will be corporately used to gain the predictive parameters corresponding to Taiwan, Japan and America; therefore, after an American user inputs the user information of the current stage at the second input unit, the second processing unit adopts standard A predictive parameters to implement prediction, the corresponding information can be gained, the information such as weight, weight change, BMI, BMI change, waist to hip ratio can be output from the output unit; that is to say, in the future, the users from everywhere all can gain the prediction information according the corresponding predictive parameters through the weight prediction system of this invention. Therefore, the weight prediction system of this invention can provide more accurate prediction.

Although this invention has been described above, the embodiments are not used to limit the spirit and physical form of this invention. For those who are skilled in this field, this invention is easy to understand and the same effect can be generated using other elements or methods. The modification without departing from the spirit and scope of this invention should all be included in the following claims.

What is claimed is:

1. A weight prediction method, comprising:
a. providing the first-period data and the second-period data of a group basic users and a plurality group of proving users, respectively;
b. using an Artificial Neural Network (ANN) method to analyze the first-period data and second-period data of basic users to gain a basic parameter;
c. analyzing the first period user data of one of the groups of the proving users using a Fuzzy Inference system according to the basic parameter and further gain a predictive data;
d. comparing the predictive data with the second-period data of proving users and determining if the predictive data is in the predicted acceptable range; and
e. If the predictive data falls in the acceptable range, the basic parameter is defined as a predictive parameter.

2. The weight prediction method of claim 1 further includes adjusting the basic parameters if the predictive data does not fall in the predetermined acceptable range and repeating step C.

3. The weight prediction method of claim 1, wherein the user information includes basic information, body shape information, mental status, life style information, gene information and weight data.

4. The weight prediction method of claim 3, wherein the gene information includes practicing gene examination to gain genetic information.

5. A weight prediction system, including:
a first input unit, used to, receive user information from a plurality of regions, wherein the user information of each region is further divided into a group of basic user information and a plurality of groups of proving user information;
a first processing unit, connected to the first input unit having an Artificial Neural Network (ANN) and a Fuzzy Inference system (FIS), with the analysis of ANN on the basic user information, a plurality of basic parameters that corresponds to each region can be gained, and the Fuzzy Inference system will further analyze the proving user information of each region to examine and adjust the basic parameter to produce a plurality of predictive parameters that corresponds to each region.
a second input unit, used to receive user information;
a second processing unit, connected to the first processing unit and the second input unit, analyzing the user information of the second input unit according to one of the predictive parameters of the first processing unit to gain predictive information; and
an output unit, connected to the second input unit and the second processing unit to output the predictive information.

6. The weight prediction system of claim 5, wherein the user information includes basic data, body shape data, mental status data, lifestyle data, genetic data and weight data.

7. The weight prediction system of claim 6, wherein the genetic information includes gene examination to gain genetic information.

8. The weight prediction system of claim 5, wherein the predictive information includes weight value, weight change amount, BMI, BMI change amount, waist to hip ratio.

9. The weight prediction system of claim 5 further including a storage unit used to store user information and the predictive information.

10. The weight prediction system of claim 5, further including a network unit, the second input unit receive the user information through the network unit.
